(19) United States
(12) Patent Application Publication
(10) Pub. No.: US 2022/0217548 A1
(43) Pub. Date: Jul. 7, 2022

(54) Continuously Evolving Network Infrastructure with Real-Time intelligence

(71) Applicant: Parallel Wireless, Inc., Nashua, NH (US)

(72) Inventors: Kaitki Agarwal, Westford, MA (US); Fernando Cerioni, Lancaster, MA (US); Steven Paul Papa, Windham, NH (US)

(21) Appl. No.: 17/549,842

(22) Filed: Dec. 13, 2021

Related U.S. Application Data
(60) Provisional application No. 63/124,293, filed on Dec. 11, 2020.

(51) Int. Cl. H04W 24/02; H04W 28/16

(52) U.S. Cl. CPC H04W 24/02; H04W 28/16

(57) ABSTRACT

Systems, methods and computer software are disclosed for providing a Diameter multifold message. In one embodiment a method is disclosed, comprising: providing a multifold-command Attribute Value Pair (AVP), the multifold-command AVP including an AVP code, a set of VMP flags, an AVP length and a vendor ID; including the AVP in a Capabilities Exchange Request (CER) command for a Diameter stack supporting multiplexing of commands in one message; and using the AVP to combine messages from multiple applications running on a single Diameter node and multiple commands from a single application.

### CROSS-REFERENCE TO RELATED APPLICATIONS

This application claims priority under 35 U.S.C. § 119(e) to U.S. Provisional Pat. App. No. 63/124,293, filed Dec. 11, 2020, titled “Continuously Evolving Network Infrastructure with Real-Time Intelligence” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

It is expected that 4G and 5G will experience substantial market growth in the next few years. The virtual Evolved Packet Core (vEPC) market is projected to grow from $970M in 2017 to 7.9 B in 2022. 5G will be fifteen percent of global market conenctions by 2025. 4G will still be strong with about sixty percent of total connections by 2025. The 5G infrastructure market is expected to be around $35B. The drivers of this are an increase in mobile subs, lower Capital Expenditures (CapEX) and Operating expenses (OPex).

Operators are adopting cloud-based EPC due to reliability, scalability, flexibility, and low costs. Cloud-based EPC states are stateless, clustered elements providing better performance and availability. Overall adoption of cloud-based solutions is still nascent.

Mobile Network Operators (MNOs) also adopting Cores that allow WiFi integration: support VoLTE & VoWiFi services. Starting in 2018: most operators upgrade their existing EPC cores rather than building new 5G Core. Based on end-user, vEPC market is divided in Enterprise & Telecom Operators: latter has 70% share of that market.

Key EPC/5GC Use Cases include Fixed Broadband Wireless Access; Long-Term Evolution (LTE) and Voice over LTE (VoLTE); Internet of Things (IoT) and Machine to Machine (M2M); MNO; and Mobile Virtual Network Operator (MVNO).

### SUMMARY

Systems, methods and computer readable media are described for operating a wireless network system having a protocol fusion engine. In one embodiment a method includes operating a converged dataplane at an edgecore, with multiple access integration; providing 4G/5G/WiFi control plane unification; and using the protocol fusion engine with a shared pool of information collected about the network to predict and analyze network behavior and making adjustments to the network to provide better performance of the network.

In another embodiment a wireless network system having a protocol fusion engine includes a converged dataplane at an edgecore, with multiple access integration; 4G/5G/WiFi control plane unification; and wherein the protocol fusion engine uses a shared pool of information collected about the network to predict and analyze network behavior and make adjustments to the network to provide better performance of the network.

In another embodiment, a non-transitory computer-readable medium containing instructions for operating a wireless network system having a protocol fusion engine which, when executed, cause the system to perform steps including operating a converged dataplane at an edgecore, with multiple access integration; providing 4G/5G/WiFi control plane unification; and using the protocol fusion engine with a shared pool of information collected about the network to predict and analyze network behavior and making adjustments to the network to provide better performance of the network.

### BRIEF DESCRIPTION OF THE DRAWINGS

FIG. 1 is a diagram showing building blocks of a protocol fusion engine, in accordance with some embodiments.

FIG. 2 is a diagram showing a fusion application suite, in accordance with some embodiments.

FIG. 3 is a diagram showing VAS applications at the edge, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

A continuous evolving network infrastructure with real-time intelligence has many uses, and solves customer problems via innovation. Table 1 shows different customer problems and technology solutions.

TABLE 1

| Customer Problem | Technology Solution |
|---|---|
| Infrastructure Investment-> Low ROI | Future Proof. programmable, expendable |
| | Network Infrastructure |
| High spend on OPEX | Predictive Analytics: Built in intelligence, |
| | automation and efficiencies at various |
| | level in product to allow operators to |
| | reduce OPEX |
| Supporting Legacy Infrastructure | Support interoperability with legacy |
| | infrastructure for smooth transition to new |
| | technology. Virtualize and replace legacy |
| | infrastructure. |
| Increasing Data Demand | VPP/DPDK based innovation to provide |
| | an optimized datapath for high throughput |
| 5 G services demanding major changes in | 4G-5GIWF and Edge Core with GiLAN |
| New Infrastructure | innovation |
| Supporting New Use Cases | Programmability and open APis |
| Roaming cost and complexity of roaming | Cloud based hosted solution for roaming |
| agreement | with new business models |

Continuous evolution via programmable engine with infrastructure-class performance, adapt to fast changing technology trends in 5G journey. Promote interoperability, protect investment by adopting custom changes and next generation requirements without forklift upgrade. Intelligence via ability to share User/Service/Network info across all RAN technologies & protocols. Neuron Data Cache.

Use the shared pool of information to predict and analyze network behavior and make adjustments for better QoE (having knowledge of all RAN technologies in single place at the Edge, provides ability to do seamless User QoE across 4G/5G/WiFi/Fixed).

Real Time “Heuristic” engine for fast learning and adaptability to changing Network conditions. Combines data from multiple points in network, RAN, Core, probes and Analytics Engine to apply changes at User & Flow level. Fully distributed self learning Data engine allows for decisions made ‘on site’, as well as work with central brain.

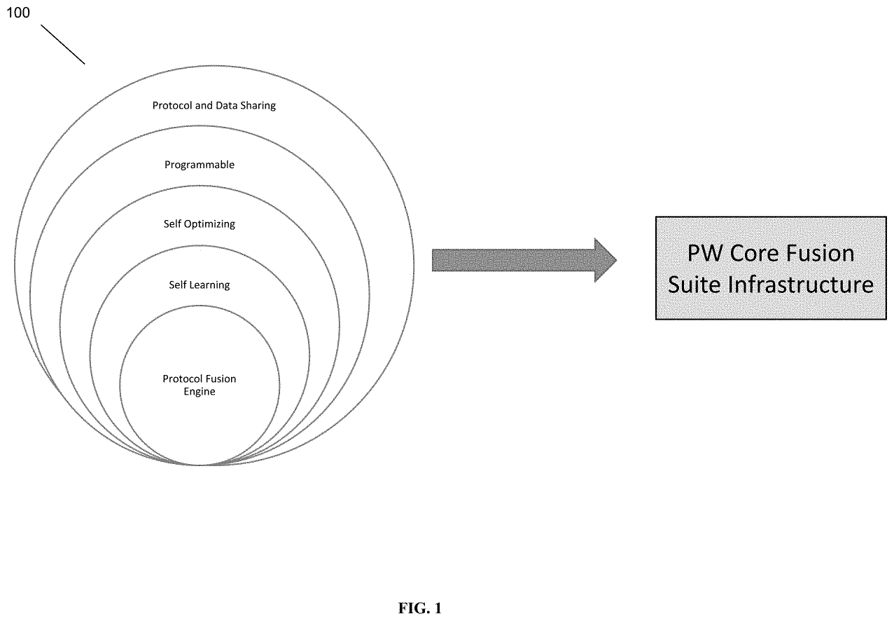

FIG. 1 shows the building block of a protocol fusion engine 100. The building blocks include programmability, data sharing, and heuristic.

Core Fusion Suite—scalable, decomposed, deployable anywhere in the network Four pillars of Differentiation:

1. Converged DataPlane at EdgeCore, with Multiple Access Integration—“All-G+WiFi”+Fixed in same Converged Core. Control at individual user/session level, across the Converged Data Plane. Geographically Distributed DataPlane; support multiple network topologies of any size. Multi-Tenant System: differentiated levels.

2. 4G/5G/WiFi Control Plane Unification (aka “Fusion”) —2 Use Cases increase Goal: ease evolution to 5G (better TCO than ‘lift and shift’). Use Case 1: 4G and 5G services via single 5G Core. Use Case 2: 4G and 5G services via single 4G/EPC Core. Get insight on User information, to better optimize applications offered by the Suite (by having a view on User's info).

3. Seamless Integration and Optimization (Mgmt., SON, App Suite Mgmt.,) of functions at the Edge. Trusted Reporting, Billing and Management functions. Fusion Intelligent Optimizing Network Applications Suite.

4. Innovative platform, restful APIs for programmability->Push it to standards for wider adoption. Overall Mentality is capabilities versus simply standards. Looking at the MNO's Network Modernization problem from another approach.

4G, 5G, and WiFi at the Edge, with Latency awareness, and optimization across technologies. Network Slicing across technologies. Local Breakout (LBO). Cross-technology interoperability (4G-5G, 5G-WiFi). Broadband Data Roaming, Neutral Host, MVNO Enablement. ION—Intelligent Optimizing Network applications suite. Provides FCAPS, radio network optimization, analytics, automation, network orchestration (optional, can use container orchestration here). Enterprise 5G Services. Markets such as Cable, CBRS and IOT. Service Fusion/Integrated GiLAN Services/Flexible Chaining concept.

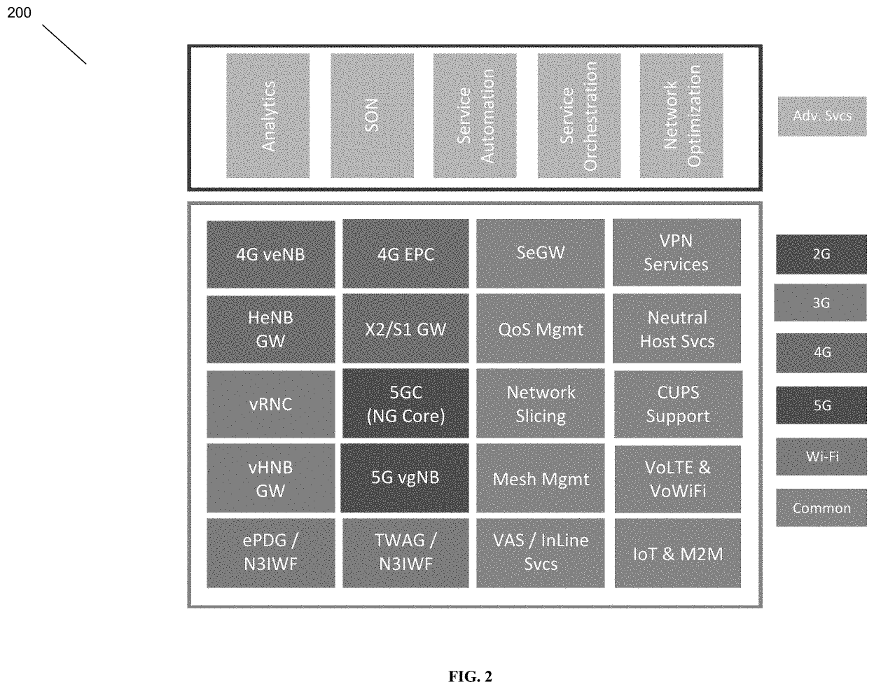

Referring now to FIG. 2, diagram 200 shows GiLAN/VAS Suite anywhere in the Network: Centralized and/or at the Edge. The “Gi” (Gateway-Internet) LAN interface (referred to as the sGi-LAN in 4G networks) is the reference point defined by the 3rd Generation Partnership Project (3GPP) as the interface between a communications service provider's mobile packet gateway and an external packet data network (such as the Internet).

GiLAN/Value Added Services. Critical component for any Core Network, Centralized or Distributed. Network Intelligence lies with the Core, benefits seen Network-wide. Enabler for Network Monetization for MNOs. Savings in TCO+Increased User stickiness justifies investment in these VAS features in Core/EdgeCore.

GiLAN differentiation: Analytics-driven, Converged Data Plane Analytics (data from HNG & EdgeCore), Edge and Centralized GiLAN options, and Intelligent Service Chaining

Example: Use Analytics to predict user's behavior to allocate resources e.g. if user does streaming at a particular time and user is paying for premium service bandwidth is managed in advance for them to do good quality streaming.

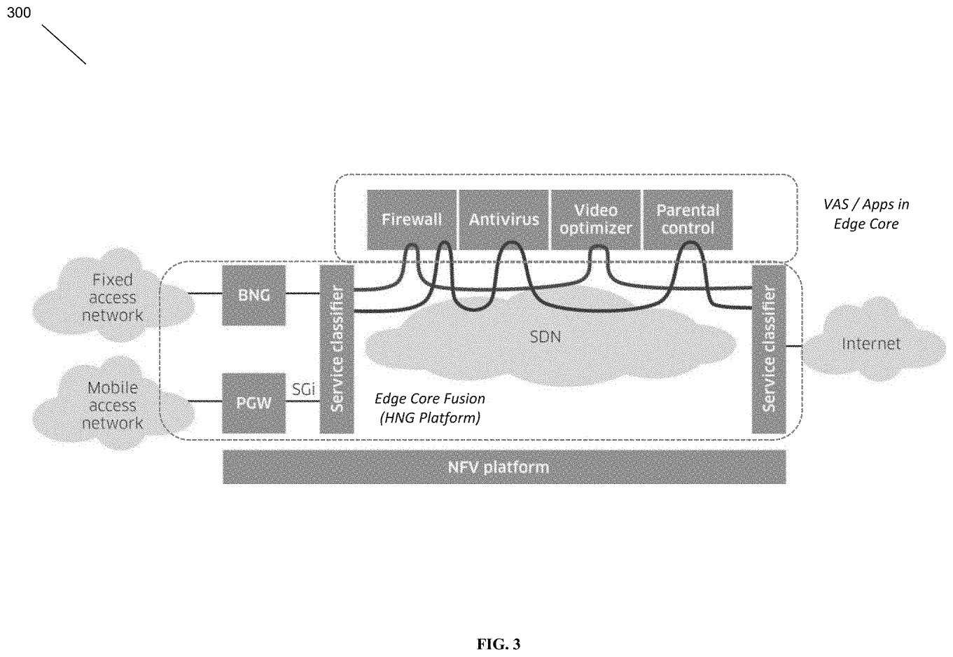

VAS Applications 300 at the edge are shown in FIG. 3. Better than “traditional” chaining. Same set of VAS for Multiple Access (Mobile, Fixed, WiFi). Intelligence at the Edge. Per User/Session granular control at both Control and DataPlane. Seamless QoE regardless of Access Method. One or more Access Methods for same subscriber depending on needs. High Throughput/Dual Connectivity, Low Latency, Different QoS levels. All wrapped with Enterprise-grade Security.

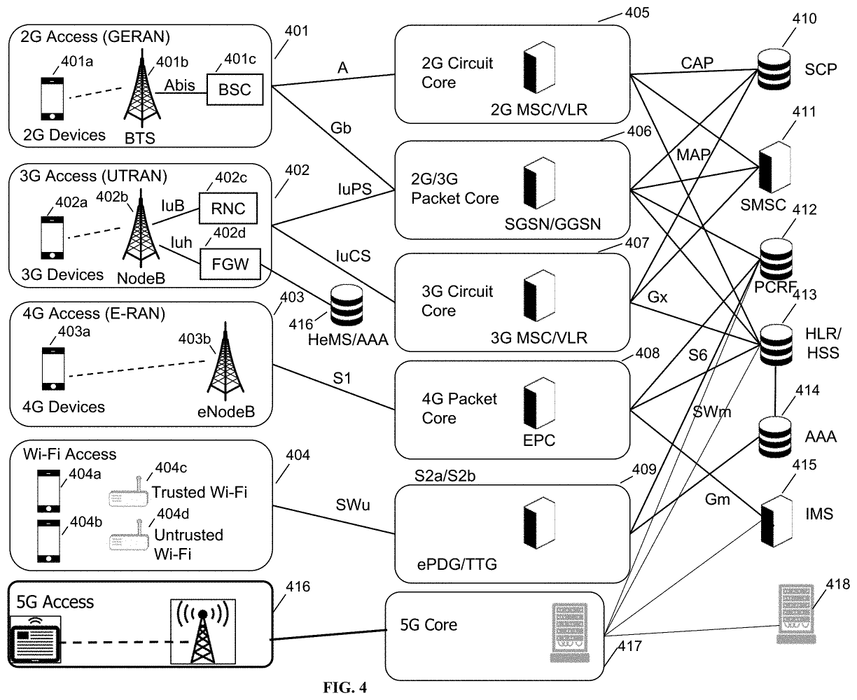

FIG. 4 is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

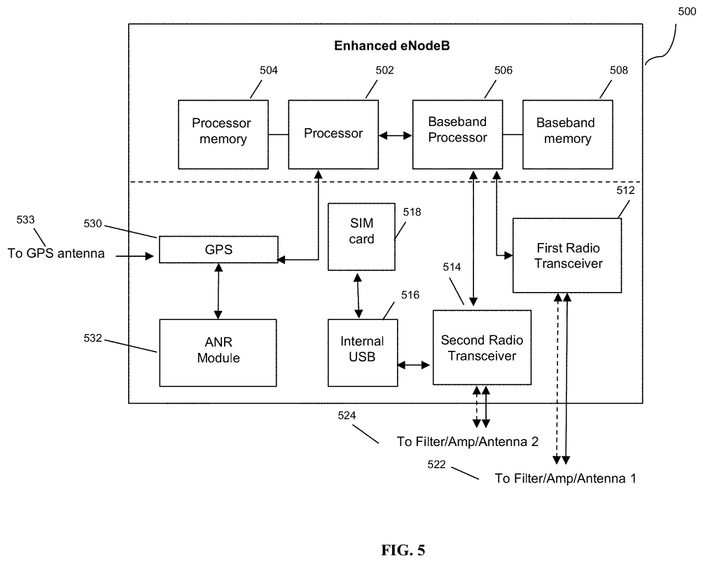

FIG. 5 is an enhanced eNodeB for performing the methods described herein, in accordance with some embodiments. Mesh network node 600 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

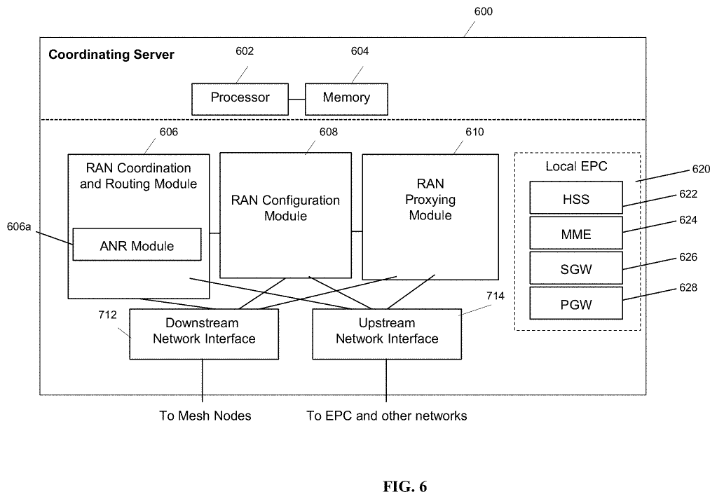

FIG. 6 is a coordinating server for providing services and performing methods as described herein, in accordance with some embodiments. Coordinating server 700 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A wireless network system having a protocol fusion engine, comprising:
a converged dataplane at an edgecore, with multiple access integration;
4G/5G/WiFi control plane unification; and
wherein the protocol fusion engine uses a shared pool of information collected about the network to predict and analyze network behavior and make adjustments to the network to provide better performance of the network.

2. The wireless network system of claim 1 wherein the network provides network slicing across technologies.

3. The wireless network system of claim 1 wherein the network provides cross-technology interoperability.

4. The wireless network system of claim 1 wherein the system provides seamless QoE regardless of an access method.

5. The wireless network system of claim 1 provides per user granular control at one or more of a control plane and a data plane.

6. The wireless network system of claim 1 provides per session granular control at one or more of a control plane and a data plane.

7. A method of operating a wireless network system having a protocol fusion engine, comprising:
operating a converged dataplane at an edgecore, with multiple access integration;
providing 4G/5G/WiFi control plane unification; and
using the protocol fusion engine with a shared pool of information collected about the network to predict and analyze network behavior and making adjustments to the network to provide better performance of the network.

8. The method of claim 7 further comprising providing network slicing across technologies.

9. The method of claim 7 further comprising providing cross-technology interoperability.

10. The method of claim 7 further comprising providing seamless QoE regardless of an access method.

11. The method of claim 7 further comprising providing per user granular control at one or more of a control plane and a data plane.

12. The method of claim 7 further comprising providing per session granular control at one or more of a control plane and a data plane.

13. A non-transitory computer-readable medium containing instructions for operating a wireless network system having a protocol fusion engine which, when executed, cause the system to perform steps comprising:
operating a converged dataplane at an edgecore, with multiple access integration;
providing 4G/5G/WiFi control plane unification; and
using the protocol fusion engine with a shared pool of information collected about the network to predict and analyze network behavior and making adjustments to the network to provide better performance of the network.

14. The computer-readable medium of claim 13 further comprising instructions for providing network slicing across technologies.

15. The computer-readable medium of claim 13 further comprising instructions for providing cross-technology interoperability.

16. The computer-readable medium of claim 13 further comprising instructions for providing seamless QoE regardless of an access method.

17. The computer-readable medium of claim 13 further comprising instructions for providing per user granular control at one or more of a control plane and a data plane.

18. The computer-readable medium of claim 13 further comprising instructions for providing per session granular control at one or more of a control plane and a data plane.
